(19) United States
(12) Patent Application Publication
(10) Pub. No.: US 2017/0307287 A1
(43) Pub. Date: Oct. 26, 2017

(54) APPARATUS FOR SENSING TEMPERATURE OF REFRIGERATOR

(71) Applicant: LG ELECTRONICS INC., Seoul (KR)

(72) Inventor: Changgyu JUN, Seoul (KR)

(73) Assignee: LG Electronics Inc.

(21) Appl. No.: 15/441,682

(22) Filed: Feb. 24, 2017

(30) Foreign Application Priority Data
Apr. 22, 2016 (KR) 10-2016-0049564

(51) Int. Cl. F25D 29/00; G01K 7/22

(52) U.S. Cl. CPC F25D 29/00; G01K 7/22; F25D 2400/30; F25D 2400/36; F25D 2700/122; F25D 2700/12

(57) ABSTRACT

The present disclosure relates to an apparatus for sensing the temperature of a refrigerator having a deep freezer compartment. A voltage value outputted from a temperature sensing unit is amplified according to a predetermined amplification ratio. Thereby, when a temperature is measured within the same temperature range, the range of voltage values output from the temperature sensing unit may be significantly widened. The temperature sensing apparatus is particularly adapted for temperature sensing of a deep freezer compartment, which has a temperature lower than a typical refrigeration compartment or freezer compartment.

### CROSS-REFERENCE TO RELATED APPLICATION(S)

This application claims priority under 35 U.S.C. §119 to Korean Application No. 10-2016-0049564 filed on Apr. 22, 2016, whose entire disclosure is herein incorporated by reference.

### BACKGROUND

### 1. Field

The present disclosure relates to an apparatus for sensing the temperature of a refrigerator, and more particularly, to an apparatus for sensing the temperature of a refrigerator having a deep freezer compartment.

### 2. Background

A refrigerator typically has a compressor, a condenser, an expansion valve, and an evaporator. The refrigerator discharges cold air produced according to a predetermined refrigeration cycle to decrease the temperature in a compartment to keep food in a frozen state or cold state. Typically, a refrigerator includes a freezer compartment and a refrigeration compartment to store food. The freezer compartment is configured to keep food or beverages in a frozen state, and the refrigeration compartment is configured to keep food or beverages at a low temperature. Recently, a refrigerator having a separate compartment for cooling food to an extremely low temperature in a short time and keeping food at the extremely low temperature, namely a refrigerator having a deep freezer compartment, has been released. A refrigerator having the deep freezer compartment is useful for storage of food such as tuna that needs to be kept at an extremely low temperature.

In a typical refrigerator, the refrigeration compartment has a temperature range between 0° C. and 5° C., and the freezer compartment has a temperature range between −15° C. and −30° C. In contrast, a deep freezer compartment has a temperature range between −20° C. and −60° C., which is lower than the temperature range of the freezer compartment of a typical refrigerator.

Such a refrigerator requires accurate and precise temperature control according to a temperature set by the user or according to a predetermined refrigeration cycle. If the temperature control is not properly performed, food stored in the refrigerator may become bad or rotten. To implement accurate and precise temperature control, the temperature in the refrigeration compartment or freezer compartment should be accurately sensed.

FIG. 1 is a diagram illustrating an apparatus for sensing the temperature of a refrigerator according to the prior art. A conventional temperature sensing apparatus as shown in FIG. 1 is installed in the refrigeration compartment or freezer compartment of a refrigerator to sense the temperature in the refrigeration compartment or freezer compartment. Referring to FIG. 1, the apparatus for sensing the temperature of the refrigerator according to the prior art includes a sensor 102 to sense an in-compartment temperature, a reference resistor R11 connected to the sensor 102, a resistor R12 and capacitor C11 to remove noise from a voltage value output from the sensor 102, and a temperature determination unit (or processor) 104 to determine the in-compartment temperature based on the voltage value output from the sensor 102.

The sensor 102 outputs different voltage values according to temperature changes in the compartment. The output voltage value is inputted to the temperature determination unit 104. The temperature determination unit 104 converts the input voltage value into a digital value through an analog-to-digital converter (ADC), and determines the current temperature in the compartment based on the converted digital value. For example, the conventional temperature sensing apparatus as shown in FIG. 1 determines the temperature in the compartment based on the converted digital value, with reference to data as shown in Table 1.

TABLE 1

| | Voltage | Digital | |
|---|---|---|---|
| Temperature | value | value | Difference |
| −30 | 2.344 | 480 | 1.154 |
| −29 | 2.349 | 481 | 1.120 |
| −28 | 2.355 | 482 | 1.116 |
| −27 | 2.360 | 483 | 1.139 |
| −26 | 2.366 | 484 | 1.106 |
| −25 | 2.371 | 486 | 1.130 |
| −24 | 2.377 | 487 | 1.097 |
| −23 | 2.382 | 488 | 1.093 |
| −22 | 2.387 | 489 | 1.116 |
| −21 | 2.393 | 490 | 1.084 |
| −20 | 2.398 | 491 | 1.079 |
| −19 | 2.403 | 492 | 1.102 |
| −18 | 2.409 | 493 | 1.071 |
| −17 | 2.414 | 494 | 1.066 |
| −16 | 2.419 | 495 | 1.062 |
| −15 | 2.424 | 496 | 1.085 |
| −14 | 2.430 | 498 | 1.053 |
| −13 | 2.435 | 499 | 1.049 |
| −12 | 2.440 | 500 | 1.045 |
| −11 | 2.445 | 501 | 1.067 |
| −10 | 2.450 | 502 | 1.037 |
| −9 | 2.455 | 503 | 1.032 |
| −8 | 2.460 | 504 | 1.028 |
| −7 | 2.465 | 505 | 1.024 |
| −6 | 2.470 | 506 | 1.020 |
| −5 | 2.475 | 507 | 1.042 |
| −4 | 2.480 | 508 | 1.012 |
| −3 | 2.485 | 509 | 1.008 |
| −2 | 2.490 | 510 | 1.004 |
| −1 | 2.495 | 511 | 1.000 |
| 0 | 2.500 | 512 | 0.996 |

As shown in Table 1, the sensor 102 included in the conventional temperature sensing apparatus outputs 2.344 V as a voltage value when the in-compartment temperature is −30° C., and outputs 2.500 V as a voltage value when the in-compartment temperature is 0° C. Accordingly, the in-compartment temperature is measured through a voltage range whose width is 0.156 V. In addition, when the in-compartment temperature changes by 1° C., the voltage value indicated by the sensor 102 changes by about 0.005 V.

With the temperature sensing apparatus according to the prior art, a temperature change in the compartment is determined based on a very small amount of change in voltage. In particular, if such a conventional temperature sensing apparatus is used to sense the temperature in a deep freezer compartment having a temperature range between −20° C. and −60° C., the in-compartment temperature is measured through a voltage range whose width is about 0.23 V. Due to this restriction, it is difficult to precisely and accurately sense the temperature of a refrigerator having a deep freezer compartment using the temperature sensing apparatus shown in FIG. 1.

Accordingly, there is a need for a temperature sensing apparatus capable of more accurately and precisely sensing the temperature of a refrigerator having a deep freezer compartment than the conventional temperature sensing apparatus.

### BRIEF DESCRIPTION OF DRAWINGS

The embodiments will be described in detail with reference to the following drawings in which like reference numerals refer to like elements wherein:

FIG. 1 is a diagram illustrating configuration of an apparatus for sensing the temperature of a refrigerator according to the prior art.

FIG. 2 is a diagram illustrating configuration of an apparatus for sensing the temperature of a refrigerator according to an embodiment of the present disclosure.

FIG. 3 is a diagram illustrating configuration of an apparatus for sensing the temperature of a refrigerator according to another embodiment of the present disclosure.

FIG. 4 illustrates a display unit for displaying the temperature of a freezer compartment and a refrigeration compartment according to an embodiment of the present disclosure.

FIG. 5 illustrates a display unit for displaying the temperature of a freezer compartment and a refrigeration compartment according to another embodiment of the present disclosure.

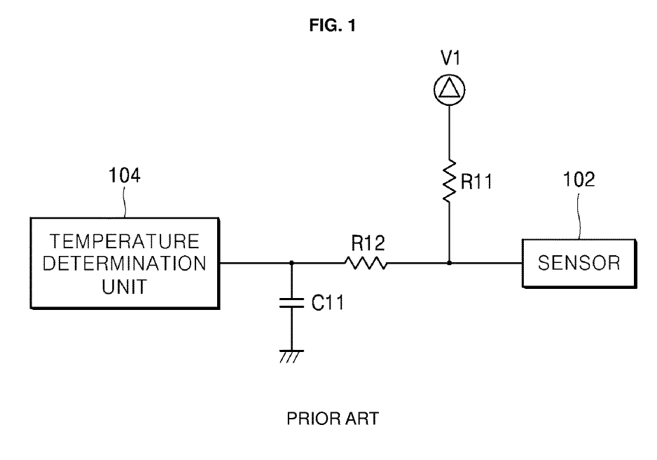

### DETAILED DESCRIPTION

The above objects, features and advantages will become apparent from the detailed description with reference to the accompanying drawings. Embodiments are described in sufficient detail to enable those skilled in the art in the art to easily practice the technical idea of the present disclosure. Detailed descriptions of well known functions or configurations may be omitted in order not to unnecessarily obscure the gist of the present disclosure. Hereinafter, embodiments of the present disclosure will be described in detail with reference to the accompanying drawings. Throughout the drawings, like reference numerals refer to like elements.

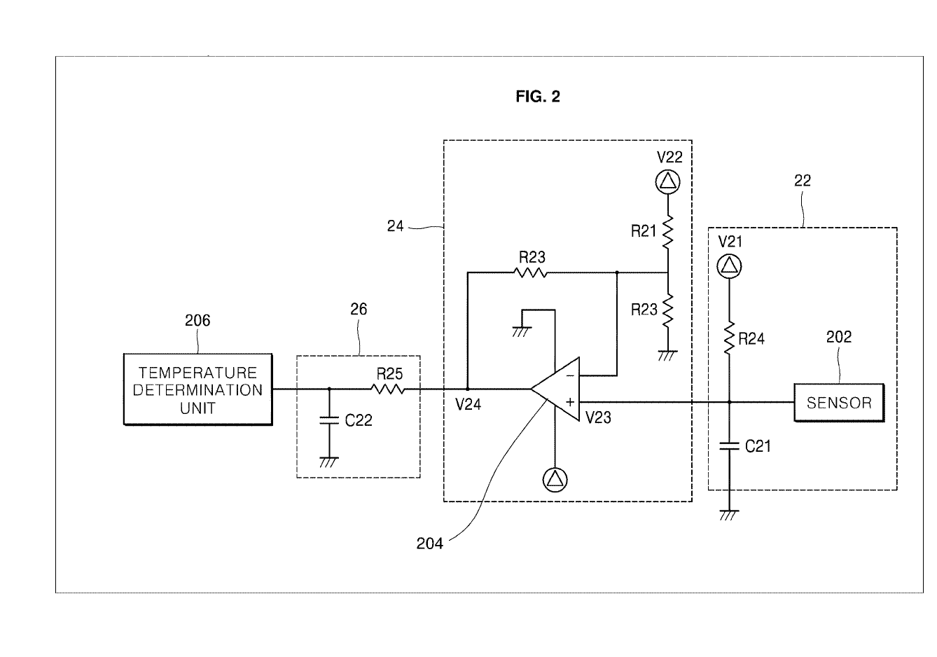

FIG. 2 is a diagram illustrating configuration of an apparatus for sensing the temperature of a refrigerator according to an embodiment of the present disclosure. Referring to FIG. 2, an apparatus for sensing the temperature of a refrigerator 1 according to an embodiment of the present disclosure includes a temperature sensing unit (or circuit) 22, a voltage amplification unit (or circuit) 24, and a temperature determination unit (or processor) 206. In one embodiment, the apparatus for sensing the temperature of the refrigerator may further include a filter unit (or circuit) 26.

The temperature sensing unit 22 senses the temperature of a freezer compartment or refrigeration compartment in a refrigerator, and outputs a voltage value according to the temperature of the compartment. In this embodiment, the temperature sensing unit 22 senses the temperature of a deep freezer compartment having a specific temperature range, for example, a range between −20° C. and −60° C., and outputs a voltage value corresponding to the temperature.

As shown in FIG. 2, the temperature sensing unit 22 includes a sensor 202 and a reference resistor R24. The temperature sensing unit 22 is configured to sense temperature change in a freezer compartment, for example, a deep freezer compartment. The sensor 202 may include an internal resistor having a resistance value that varies according to the temperature of a compartment which the sensor is intended to sense. According to an embodiment of the present disclosure, a negative temperature coefficient (NTC) thermistor having an internal resistance value, which decreases when the temperature of the surroundings of the thermistor increases, and/or a positive temperature coefficient (PTC) thermistor having an internal resistance value, which increases when the temperature of the surroundings of the thermistor increases may be used as the sensor 202.

The reference resistor R24, which is connected to the sensor 202, modifies a voltage supplied from a sensing power source V21. As described above, the temperature sensing unit 22 outputs a voltage value according to change in temperature of the deep freezer compartment. The voltage value outputted by the temperature sensing unit 22 is a value given when the voltage supplied by the sensing power source V21 is modified by the internal resistor included in the sensor 202 and the reference resistor R24. In one embodiment of the present disclosure, the value of the reference resistor R24 may be adjusted to cause the temperature sensing unit 22 to output different voltage values at the same temperature. In one embodiment of the present disclosure, the reference resistor R24 may have 1 kΩ as a resistance value.

In another embodiment of the present disclosure, the temperature sensing unit 22 may further include a capacitor 21 to stabilize a voltage which is distributed by the reference resistor R24 and/or the internal resistor of the sensor 202, as shown in FIG. 2.

The temperature sensing unit 22, configured as above, outputs different voltage values according to change in temperature at a place where the temperature sensing unit 22 is installed. The output voltage value is input to the voltage amplification unit 24.

The voltage amplification unit 24 amplifies the voltage value output from the temperature sensing unit 22 according to a predetermined amplification ratio and outputs the amplified voltage value. As described above, in this embodiment, to more precisely and accurately perform temperature sensing, the voltage value output from the temperature sensing unit 22 is amplified. Thereby, the amount of voltage change may increase for the same amount of temperature change, in comparison to the conventional technology. As the amount of voltage change corresponding to the amount of temperature change increases, the temperature change according to the voltage change may be more clearly identified, and thus, stable and precise temperature sensing may be implemented.

Referring to FIG. 2, the voltage amplification unit 24 includes an amplification device (or amplifier) 204, a first distribution resistor R21, a second distribution resistor R22, and a feedback resistor R23. The amplification device 204 amplifies the magnitude of an input voltage according to a predetermined amplification ratio. In one embodiment of the present disclosure, an operating amplifier (OP AMP) may be used as the amplification device 204. As shown in FIG. 2, the amplification device 204 receives a distribution voltage distributed by the first distribution resistor R21 and second distribution resistor R22 and receives a voltage V23 output from the temperature sensing unit 22. The amplification device 204 amplifies the voltage V23 output from the temperature sensing unit 22 according to a predetermined amplification ratio and outputs an amplified voltage V24.

In one embodiment of the present disclosure, the amplification ratio of the amplification device 204 may be determined depending on the resistance values of the first distribution resistor R21, second distribution resistor R22, and feedback resistor R23. As shown in FIG. 2, the first distribution resistor R21 and the second distribution resistor R22 are connected in series and are configured to distribute a reference voltage output from a reference voltage source V22. The feedback resistor R23 is connected between the connection point of the first distribution resistor R21 and second distribution resistor R22 and the output terminal of the amplification device 204. In one embodiment of the present disclosure, the first distribution resistor R21 may have 1.2 kΩ, the second distribution resistor R22 may have 1 kΩ, and the feedback resistor R23 may have 2 kΩ as resistance values.

The temperature determination unit 206 may determine the temperature in the deep freezer compartment based on the amplified voltage value V24 output from the voltage amplification unit 24. In one embodiment of the present disclosure, the temperature determination unit 206 may include an analog-to-digital converter (ADC) (not shown) to convert the amplified voltage value V24 output from the voltage amplification unit 24 into a digital value. Using the ADC, the temperature determination unit 206 may convert the amplified voltage value V24 output from the voltage amplification unit 24 into a digital value, and determine a temperature corresponding to the digital value as the final temperature of the deep freezer compartment according to predetermined data.

In one embodiment of the present disclosure, the temperature sensing apparatus may further include a filter unit 26 to remove noise from the amplified voltage value output from the voltage amplification unit 24, as shown in FIG. 2. In one embodiment of the present disclosure, the filter unit 26 may include a resistor R25 and a capacitor C22, as shown in FIG. 2.

As described above, the deep freezer compartment has a temperature range between −20° C. and −60° C. Accordingly, in one embodiment of the present disclosure, the temperature sensing apparatus preferably senses a temperature in the range between −20° C. and −60° C. However, according to another embodiment of the present disclosure, in case that the deep freezer compartment has a temperature outside the range between −20° C. and −60° C., the temperature sensing apparatus may sense a temperature in a range between −10° C. and −70° C. or a different range, such as a range that includes colder temperatures.

After the refrigerator with the deep freezer compartment begins to operate, a certain time passes before the freezer compartment is sufficiently cooled. Accordingly, during a period before the deep freezer compartment is sufficiently cooled, the temperature of external air present outside the refrigerator, which is higher than or equal to −10° C., may be sensed by the temperature sensing apparatus. As the temperature of the external air is sensed, the user may misrecognize that the refrigerator or the temperature sensing apparatus malfunctions even when the refrigerator is operating normally. In particular, if a refrigerator provided with a deep freezer compartment is used in a high-temperature area such as Africa, the external air temperature up to 70° C. may be sensed by the temperature sensing apparatus. Therefore, the external air temperature should be taken into account in determining the measurable temperature range of the temperature sensing apparatus. Accordingly, in one embodiment of the present disclosure, the temperature sensing apparatus preferably senses the temperature in the deep freezer compartment within a range between −70° C. and 70° C.

Table 2 shows examples of voltage values output from a conventional temperature sensing apparatus (i.e., “conventional voltage values”) and voltage values output from the temperature sensing unit 22 (i.e., “amplified voltage values”), as the temperature is measured in a range between −70° C. and 70° C.

TABLE 2

| Temperature | Conventional voltage value | Amplified Voltage value |
|---|---|---|
| −70 | 2.099 | 1.460 |
| −69 | 2.105 | 1.491 |
| −68 | 2.112 | 1.523 |
| −67 | 2.119 | 1.554 |
| −66 | 2.125 | 1.585 |
| −65 | 2.132 | 1.615 |
| −64 | 2.138 | 1.646 |
| −63 | 2.145 | 1.677 |
| −62 | 2.151 | 1.707 |
| −61 | 2.158 | 1.737 |
| −60 | 2.164 | 1.767 |
| −59 | 2.171 | 1.797 |
| −58 | 2.177 | 1.826 |
| −57 | 2.183 | 1.856 |
| −56 | 2.190 | 1.885 |
| −55 | 2.196 | 1.915 |
| −54 | 2.202 | 1.944 |
| −53 | 2.208 | 1.973 |
| −52 | 2.215 | 2.002 |
| −51 | 2.221 | 2.031 |
| −50 | 2.227 | 2.059 |
| −49 | 2.233 | 2.087 |
| −48 | 2.239 | 2.116 |
| −47 | 2.245 | 2.144 |
| −46 | 2.251 | 2.172 |
| −45 | 2.257 | 2.200 |
| −44 | 2.263 | 2.228 |
| −43 | 2.269 | 2.255 |
| −42 | 2.275 | 2.283 |
| −41 | 2.281 | 2.310 |
| −40 | 2.287 | 2.337 |
| −39 | 2.292 | 2.365 |
| −38 | 2.298 | 2.391 |
| −37 | 2.304 | 2.419 |
| −36 | 2.310 | 2.445 |
| −35 | 2.315 | 2.472 |
| −34 | 2.321 | 2.498 |
| −33 | 2.327 | 2.525 |
| −32 | 2.332 | 2.551 |
| −31 | 2.338 | 2.577 |
| −30 | 2.344 | 2.603 |
| −29 | 2.349 | 2.629 |
| −28 | 2.355 | 2.655 |
| −27 | 2.360 | 2.680 |
| −26 | 2.366 | 2.706 |
| −25 | 2.371 | 2.732 |
| −24 | 2.377 | 2.757 |
| −23 | 2.382 | 2.782 |
| −22 | 2.387 | 2.807 |
| −21 | 2.393 | 2.833 |
| −20 | 2.398 | 2.857 |
| −19 | 2.403 | 2.882 |
| −18 | 2.409 | 2.907 |
| −17 | 2.414 | 2.931 |
| −16 | 2.419 | 2.956 |
| −15 | 2.424 | 2.980 |
| −14 | 2.430 | 3.005 |
| −13 | 2.435 | 3.029 |
| −12 | 2.440 | 3.053 |
| −11 | 2.445 | 3.076 |
| −10 | 2.450 | 3.101 |
| −9 | 2.455 | 3.124 |
| −8 | 2.460 | 3.148 |
| −7 | 2.465 | 3.171 |
| −6 | 2.470 | 3.195 |
| −5 | 2.475 | 3.218 |
| −4 | 2.480 | 3.242 |
| −3 | 2.485 | 3.265 |
| −2 | 2.490 | 3.288 |
| −1 | 2.495 | 3.311 |
| 0 | 2.500 | 3.333 |
| 1 | 2.505 | 3.356 |
| 2 | 2.510 | 3.379 |
| 3 | 2.515 | 3.401 |
| 4 | 2.519 | 3.424 |
| 5 | 2.524 | 3.446 |
| 6 | 2.529 | 3.468 |
| 7 | 2.534 | 3.490 |
| 8 | 2.538 | 3.513 |
| 9 | 2.543 | 3.535 |
| 10 | 2.548 | 3.556 |
| 11 | 2.552 | 3.578 |
| 12 | 2.557 | 3.600 |
| 13 | 2.562 | 3.622 |
| 14 | 2.566 | 3.643 |
| 15 | 2.571 | 3.665 |
| 16 | 2.576 | 3.686 |
| 17 | 2.580 | 3.708 |
| 18 | 2.585 | 3.729 |
| 19 | 2.589 | 3.750 |
| 20 | 2.594 | 3.771 |
| 21 | 2.598 | 3.792 |
| 22 | 2.603 | 3.813 |
| 23 | 2.607 | 3.834 |
| 24 | 2.612 | 3.854 |
| 25 | 2.616 | 3.875 |
| 26 | 2.620 | 3.895 |
| 27 | 2.625 | 3.916 |
| 28 | 2.629 | 3.936 |
| 29 | 2.634 | 3.957 |
| 30 | 2.638 | 3.977 |
| 31 | 2.642 | 3.997 |
| 32 | 2.647 | 4.017 |
| 33 | 2.651 | 4.037 |
| 34 | 2.655 | 4.057 |
| 35 | 2.659 | 4.077 |
| 36 | 2.664 | 4.097 |
| 37 | 2.668 | 4.116 |
| 38 | 2.672 | 4.136 |
| 39 | 2.676 | 4.155 |
| 40 | 2.68 | 4.174 |
| 41 | 2.684 | 4.194 |
| 42 | 2.689 | 4.213 |
| 43 | 2.693 | 4.232 |
| 44 | 2.697 | 4.251 |
| 45 | 2.701 | 4.271 |
| 46 | 2.705 | 4.290 |
| 47 | 2.709 | 4.308 |
| 48 | 2.713 | 4.327 |
| 49 | 2.717 | 4.346 |
| 50 | 2.721 | 4.365 |
| 51 | 2.725 | 4.383 |
| 52 | 2.729 | 4.402 |
| 53 | 2.733 | 4.420 |
| 54 | 2.737 | 4.439 |
| 55 | 2.741 | 4.457 |
| 56 | 2.745 | 4.476 |
| 57 | 2.749 | 4.494 |
| 58 | 2.753 | 4.512 |
| 59 | 2.756 | 4.530 |
| 60 | 2.76 | 4.548 |
| 61 | 2.764 | 4.566 |
| 62 | 2.768 | 4.584 |
| 63 | 2.772 | 4.601 |
| 64 | 2.776 | 4.619 |
| 65 | 2.779 | 4.637 |
| 66 | 2.783 | 4.654 |
| 67 | 2.787 | 4.672 |
| 68 | 2.791 | 4.690 |
| 69 | 2.794 | 4.707 |
| 70 | 2.798 | 4.725 |

As shown in Table 2, the conventional temperature sensing apparatus uses a voltage range between 2.099 V to 2.798 V, such that a voltage range of 0.699 V is used to measure a temperature in the range between −70° C. and 70° C. In contrast, the temperature sensing apparatus according to an embodiment of the present disclosure uses a voltage range between 1.460 V to 4.725 V, namely a voltage range of 3.265 V, to measure temperatures in the same range. Compared to the conventional temperature sensing apparatus, the temperature sensing apparatus of the present disclosure generates a wider voltage range for the same temperature range, and is thus appropriate to sense the temperature of the deep freezer compartment, which requires precise and accurate temperature sensing.

The difference in voltage range between the conventional temperature sensing apparatus and the temperature sensing apparatus of the present disclosure leads to a difference in the amount of change of voltage per amount of change of temperature. For example, with the conventional temperature sensing apparatus, a temperature change by 1° C. is represented by a voltage difference of about 0.005 V. In contrast, with the temperature sensing apparatus of the present disclosure, the temperature change by 1° C. is represented by a voltage difference of about 0.03 V. Accordingly, with the temperature sensing apparatus of the present disclosure, temperature intervals may be more accurately and precisely distinguished from each other, and therefore temperature sensing may be more precisely and accurately performed than with the conventional technology.

For example, if the voltage value of the sensor 202 changes by 0.005 V due to a cause other than change in temperature, the conventional temperature sensing apparatus may misrecognize this change as indicating a change in temperature in the refrigeration compartment or freezer compartment. In contrast, with the temperature sensing apparatus according to the present disclosure, possibility of an error due to such fine change in voltage value may be significantly reduced, compared to the conventional sensor.

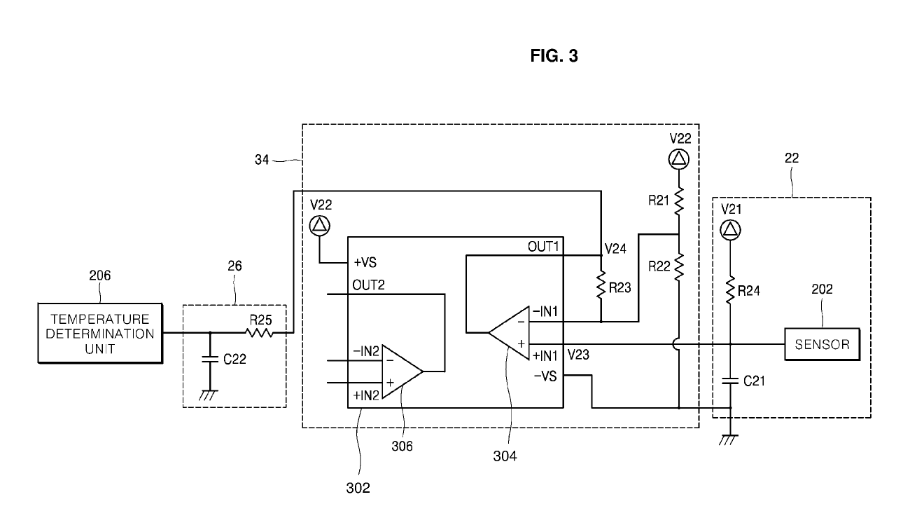

FIG. 3 is a diagram illustrating configuration of an apparatus for sensing the temperature of a refrigerator according to another embodiment of the present disclosure. Referring to FIG. 3, an apparatus for sensing the temperature of a refrigerator according to another embodiment of the present disclosure includes a temperature sensing unit 22, a voltage amplification unit 34, and a temperature determination unit 206. In one embodiment of the present disclosure, the apparatus for sensing the temperature of the refrigerator may further include a filter unit 26.

As shown in FIG. 3, the temperature sensing unit 22 includes a sensor 202 and a reference resistor R24. The functions and configurations of the temperature sensing unit 22, the sensor 202, and the reference resistor R24 are substantially the same as the temperature sensing unit 22, the sensor 202, and the reference resistor R24 shown in FIG. 2, and thus a detailed description thereof is omitted. In another embodiment of the present disclosure, the temperature sensing unit 22 may further include a capacitor 21 to stabilize a distribution voltage distributed by the reference resistor R24 or an internal resistor of the temperature sensing unit 22, as shown in FIG. 3.

The voltage amplification unit 34 amplifies a voltage value output V23 from the temperature sensing unit 22 according to a predetermined amplification ratio and outputs the amplified voltage value V24. In the embodiment of FIG. 3, the voltage amplification unit 34 includes an integrated circuit (IC) device 302 including two or more amplification devices 304, 306. Only one amplification device 304 of the two or more amplification devices 304, 306 included in the IC device 302 is used to amplify the voltage value output V23 from the temperature sensing unit 22, and the other amplification device(s) 306 may be used for other functions of the refrigerator. In another embodiment of the present disclosure, as the IC device 302 including two or more amplification devices 304, 306 as described above is used, the manufacture efficiency of the refrigerator may be increased, and the cost for manufacture may be reduced.

For reference, the functions and configurations of the amplification device 304, first distribution resistor R21, second distribution resistor R22, and feedback resistor R23 shown in FIG. 3 are substantially the same as those of the amplification device 204, first distribution resistor R21, second distribution resistor R22, and feedback resistor R23 shown in FIG. 2, and thus a detailed description thereof is omitted.

The temperature determination unit 206 may determine the temperature in the deep freezer compartment based on the amplified voltage value V24 output from the voltage amplification unit 34. In one embodiment of the present disclosure, the temperature determination unit 206 may include an analog-to-digital converter (ADC) (not shown) to convert the amplified voltage value V24 output from the voltage amplification unit 34 into a digital value. Using the ADC, the temperature determination unit 206 may convert the amplified voltage value V24 output by the voltage amplification unit 34 into a digital value, and determine a temperature corresponding to the digital value as the final temperature of the deep freezer compartment according to predetermined data.

In one embodiment of the present disclosure, the temperature sensing apparatus may further include a filter unit 26 to remove noise from the amplified voltage value output from the voltage amplification unit 34, as shown in FIG. 3. In one embodiment of the present disclosure, the filter unit 26 may include a resistor R25 and a capacitor C22, as shown in FIG. 3.

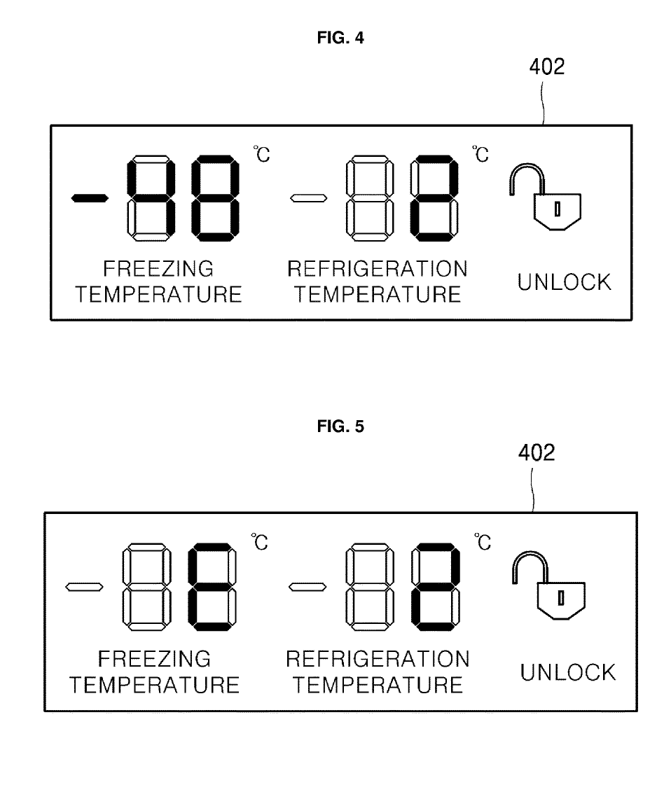

FIG. 4 illustrates a display unit for displaying the temperature of a freezer compartment and a refrigeration compartment according to an embodiment of the present disclosure, and FIG. 5 illustrates a display unit for displaying the temperature of a freezer compartment and a refrigeration compartment according to another embodiment of the present disclosure.

The temperature determination unit included in the temperature sensing apparatus of the present disclosure shown in FIGS. 2 and 3 may sense the temperature of the freezer compartment or refrigeration compartment, and the sensed temperature of the freezer compartment or refrigeration compartment may be displayed through a display unit (or display) 402 as shown in FIG. 4. In the embodiment of FIG. 4, −48° C. is displayed as the temperature of the freezer compartment, and 2° C. is displayed as the temperature of the refrigeration compartment.

If the temperature of the freezer compartment or refrigeration compartment is outside a sensible temperature range, the temperature determination unit included in the temperature sensing apparatus may display an error message through the display unit 402. For example, if the temperature of the deep freezer compartment given as a result of temperature sensing of the freezer compartment included in the refrigerator is lower than −70° C. or higher than 70° C., which is a typical range of temperatures sensible by the temperature sensing apparatus, the temperature determination unit displays an error message E on a temperature display area of the freezer compartment through the display unit 402, as shown in FIG. 5.

In one embodiment of the present disclosure, the type or form of the error message displayed on the display unit 402 may be defined by the user. For example, the user may set a message such as “--” or “EE” to be displayed if the temperature of the deep freezer compartment is outside a temperature range sensible by the temperature sensing apparatus.

With a temperature sensing apparatus according to an embodiment of the present invention, the in-compartment temperature of a refrigerator having a deep freezer compartment may be more precisely and accurately sensed. In addition, with a temperature sensing apparatus according to an embodiment of the present invention, the temperature may be more precisely and accurately sensed within a wider range than the conventional temperature sensing apparatus. Further, according to an embodiment of the present disclosure, the functions of display and control of the temperature of a refrigerator having a deep freezer compartment may be improved, and issues such as insufficient cooling and excessive cooling may be addressed, through precise and accurate temperature sensing.

The present disclosure provides a temperature sensing apparatus capable of precisely and accurately sensing the in-compartment temperature of a refrigerator having a deep freezer compartment. The present disclosure also provides a temperature sensing apparatus capable of precisely and accurately sensing a temperature within a wider range than the conventional temperature sensing apparatus. The present disclosure also provides a temperature sensing apparatus for improving the functions of temperature display and control of a refrigerator having a deep freezer compartment through precise and accurate temperature sensing and addressing issues such as insufficient cooling and excessive cooling.

It should be noted that the present disclosure is not limited to the aforementioned aspects, and other aspects of the present disclosure will be apparent to those skilled in the art from the following descriptions. In addition, it will be appreciated that the objects and advantages of the present disclosure can be implemented by means recited in the appended claims and a combination thereof.

As described above, the deep freezer compartment may have a temperature range between −20° C. and −60° C., which is lower than the temperature ranges of the freezer compartment or refrigeration compartment of a typical refrigerator. However, if a sensor is configured to indicate voltage change by about 0.005 V for change of the in-compartment temperature by 1° C., it is difficult to precisely sense the temperature due to the relatively small amount of voltage change per 1° C. For example, with the conventional temperature sensing apparatus, change in temperature needs to be sensed according to a small change in voltage, and thus, it is very likely to incorrectly sense the temperature if change in voltage of the sensor occurs due to a cause other than an actual change of temperature.

With the present disclosure devised to solve the problem above, a voltage value output from a temperature sensing unit is amplified according to a predetermined amplification ratio. Thereby, when a temperature is measured within the same temperature range, the range of voltage values output from the temperature sensing unit may be significantly widened. Accordingly, the amount of voltage change given when the in-compartment temperature changes by 1° C. increases over the case of the conventional temperature sensing apparatus, and therefore the temperature may be more precisely and accurately sensed.

In accordance with one aspect of the present disclosure, an apparatus for sensing a temperature of a refrigerator includes a temperature sensing unit to output a voltage value according to temperature change in a deep freezer compartment, a voltage amplification unit to amplify the voltage value output from the temperature sensing unit according to a predetermined amplification ratio and output the amplified voltage value, and a temperature determination unit to determine the temperature in the deep freezer compartment based on the amplified voltage value output from the voltage amplification unit.

According to an embodiment of the present disclosure, a voltage value output from the temperature sensing unit is appropriately amplified to sense a specific temperature range of a deep freezer compartment, which indicates a temperature lower than that of the refrigeration compartment or freezer compartment of a typical refrigerator. Thereby, a conventional (i.e. without an amplifier) temperature sensing apparatus may be applied to a refrigerator compartment, and the temperature of the deep freezer compartment may be more precisely and accurately sensed through the disclosed temperature sensing apparatus.

With a temperature sensing apparatus according to an embodiment of the present invention, the in-compartment temperature of a refrigerator having a deep freezer compartment may be more precisely and accurately sensed. In addition, with a temperature sensing apparatus according to an embodiment of the present invention, the temperature may be more precisely and accurately sensed within a wider range than the conventional temperature sensing apparatus. Further, according to an embodiment of the present disclosure, the functions of display and control of the temperature of a refrigerator having a deep freezer compartment may be improved and issues such as insufficient cooling and excessive cooling may be addressed, through precise and accurate temperature sensing.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An apparatus for sensing a temperature of a refrigerator, comprising:
a temperature sensing circuit to output a voltage according to a temperature change ;
a voltage amplification circuit to amplify the voltage outputted from the temperature sensing circuit according to a prescribed amplification ratio and output the amplified voltage; and
a temperature determination processor to determine the temperature in based on the amplified voltage outputted by the voltage amplification unit.

2. The apparatus according to claim 1, further comprising:
a filter circuit to remove noise from the amplified voltage outputted by the voltage amplification circuit.

3. The apparatus according to claim 1, wherein the temperature determination circuit determines the temperature within a range between −70° C. and 70° C.

4. The apparatus according to claim 1, wherein the temperature determination circuit determines the temperature within a range between 0° C. and −70° C.

5. The apparatus according to claim 1, wherein the voltage amplification circuit amplifies the voltage from the temperature sensing circuit such that the amplified voltage is within a range between 1.460 V and 4.725 V.

6. The apparatus according to claim 1, wherein the temperature sensing circuit comprises:
a sensor to change resistance based on a temperature change; and
a reference resistor to distribute a voltage supplied from a sensing power source,
wherein the temperature sensing circuit varies the supplied voltage based on the changed resistance of the sensor to form the outputted voltage.

7. The apparatus according to claim 6, wherein the sensor includes a thermistor.

8. The apparatus according to claim 1, wherein the voltage amplification circuit comprises:
a first distribution resistor and second distribution resistor to output a distribution voltage by modifying a reference voltage output from a reference power source;
an amplification device to output the amplified voltage based on receiving the distribution voltage and the output voltage from the temperature sensing circuit; and
a feedback resistor connected between a connection point of the first distribution resistor and the second distribution resistor and an output terminal of the amplification device.

9. The apparatus according to claim 6, wherein the first distribution resistor has a resistance value of 1.2 kΩ, the second distribution resistor has a resistance value of 1 kΩ, and the feedback resistor has a resistance value of 2 kΩ.

10. The apparatus according to claim 1, further comprising a display that presents an error message when the amplified voltage outputted by the voltage amplification circuit is outside of a prescribed voltage range.

11. The apparatus according to claim 1, wherein the voltage amplification circuit comprises an amplification integrated circuit (IC), the amplification IC comprising two or more amplification devices.

12. The apparatus according to claim 11, wherein one of the amplification devices amplifies the voltage outputted by the temperature sensing circuit, and another one of the amplification devices is used for another function of the refrigerator.

13. The apparatus according to claim 1, wherein the temperature relates to a deep freezer compartment of the refrigerator.

14. A method for sensing a temperature of a refrigerator, the method comprising:
modifying a voltage based on a temperature change;
amplifying the modified voltage according to a prescribed amplification ratio; and
determining the temperature in based on the amplified voltage.

15. The method of claim 14, further comprising:
filtering noise from the amplified voltage, wherein the temperature is determined based on the filtered amplified voltage.

16. The method of claim 14, wherein the temperature is within a range between −70° C. and 70° C.

17. The method of claim 14, wherein the voltage amplification circuit amplifies the voltage from the temperature sensing circuit such that the amplified voltage is within a range between 1.460 V and 4.725 V.

18. The method of claim 14, further comprising:
displaying an error message when the amplified voltage is outside of a prescribed voltage range.

19. The method of claim 14, wherein the temperature relates to a deep freezer compartment of the refrigerator.

20. The method of claim 14, wherein determining the temperature in based on the amplified voltage includes.
converting the amplified voltage into a digital value; and
determining the temperature based on the digital value
